(19) United States
(12) Patent Application Publication
(10) Pub. No.: US 2025/0104642 A1
(43) Pub. Date: Mar. 27, 2025

(54) DISPLAY DEVICE INCLUDING A SWITCHING CIRCUIT

(71) Applicant: SAMSUNG DISPLAY CO., LTD., YONGIN-SI (KR)

(72) Inventor: Hyeon Seok BAE, Yongin-si (KR)

(21) Appl. No.: 18/750,003

(22) Filed: Jun. 21, 2024

(30) Foreign Application Priority Data
Sep. 25, 2023 (KR) 10-2023-0128612

(51) Int. Cl. G09G 3/3258; G09G 3/3291

(52) U.S. Cl. CPC G09G 3/3258; G09G 3/3291; G09G 2330/021; G09G 2330/028

(57) ABSTRACT

A display device including: a first pixel including a first organic light emitting diode; and an initialization voltage generator configured to generate a first initialization voltage and a second initialization voltage, and supply one of the first initialization voltage and the second initialization voltage to a first anode of the first organic light emitting diode, in response to a select signal.

### CROSS-REFERENCE TO RELATED APPLICATION

The present application claims priority under 35 U.S.C. § 119 to Korean patent application No. 10-2023-0128612 filed on Sep. 25, 2023 in the Korean Intellectual Property Office, the disclosure of which is incorporated by reference herein in its entirety.

### 1. Technical Field

The present disclosure relates to a display device including a switching circuit.

### 2. Discussion of Related Art

As information technologies advance, the significance of display devices, which serve as the interface between a user and information, is growing. Accordingly, display devices such as liquid crystal displays and organic light emitting displays are increasingly used.

An organic light emitting display device displays an image using organic light emitting diodes, which generate light through the recombination of electrons and holes. In general, these display devices include a plurality of organic light emitting diodes, configured with red, green, and blue diodes. A driving voltage supplied to each colored organic light emitting diode can vary depending on the specific organic material used in the organic light emitting diode.

### SUMMARY

Embodiments of the present disclosure provide a display device that can supply an optimized driving voltage to an organic light emitting diode of each color through a switching circuit.

In accordance with an embodiment of the present disclosure, there is provided a display device including: a first pixel including a first organic light emitting diode; and an initialization voltage generator configured to generate a first initialization voltage and a second initialization voltage, and supply one of the first initialization voltage and the second initialization voltage to a first anode of the first organic light emitting diode, in response to a select signal.

The display device further including: a second pixel including a second organic light emitting diode; and a third pixel including a third organic light emitting diode, wherein the initialization voltage generator: supplies the first initialization voltage to a second anode of the second organic light emitting diode; and supplies the second initialization voltage to a third anode of the third organic light emitting diode.

The initialization voltage generator includes: a first Low-Dropout regulator (LDO) configured to generate the first initialization voltage; a second LDO configured to generate the second initialization voltage; and a switching circuit configured to supply one of the first initialization voltage and the second initialization voltage to the first anode of the first organic light emitting diode, in response to the select signal.

The switching circuit includes: a first transistor connected between the first anode of the first organic light emitting diode and the second anode of the second organic light emitting diode, the first transistor operating in response to the select signal; and a second transistor connected between the first anode and the third anode of the third organic light emitting diode, the second transistor operating in response to the select signal.

The first transistor is a P-type transistor, and the second transistor is an N-type transistor.

When the select signal turns on the first transistor, the first initialization voltage is supplied to the first anode of the first organic light emitting diode, and when the select signal turns on the second transistor, the second initialization voltage is supplied to the first anode of the first organic light emitting diode.

The first pixel is a green pixel, the second pixel is a red pixel, and the third pixel is a blue pixel.

In accordance with an embodiment of the present disclosure, there is provided a display device including: a display unit including a first pixel including a first organic light emitting diode and a switching circuit configured to supply one of a first initialization voltage and a second initialization voltage to a first anode of the first organic light emitting diode, in response to a select signal; and an initialization voltage generator configured to generate the first initialization voltage and the second initialization voltage.

The display device further including: a second pixel including a second organic light emitting diode; and a third pixel including a third organic light emitting diode, wherein the initialization voltage generator: supplies the first initialization voltage to a second anode of the second organic light emitting diode; and supplies the second initialization voltage to a third anode of the third organic light emitting diode.

The initialization voltage generator includes: a first LDO configured to generate the first initialization voltage; and a second LDO configured to generate the second initialization voltage.

The switching circuit includes: a first transistor connected between the first anode and the second anode, the first transistor operating in response to the select signal; and a second transistor connected between the first anode and the third anode, the second transistor operating in response to the select signal.

The first transistor is a P-type transistor, and the second transistor is an N-type transistor.

When the select signal turns on the first transistor, the first initialization voltage is supplied to the first anode, and when the select signal turns on the second transistor, the second initialization voltage is supplied to the first anode.

The first pixel is a green pixel, the second pixel is a red pixel, and the third pixel is a blue pixel.

In accordance with an embodiment of the present disclosure, there is provided a display device including: a first pixel including a first organic light emitting diode; and a switching circuit configured to apply one of a first initialization voltage and a second initialization voltage to a first anode of the first organic light emitting diode, in response to the select signal.

The switching circuit includes a first transistor that is activated in response to a first level of the select signal and a second transistor that is activated in response to a second level of the select signal.

The first transistor is connected to a first initialization voltage line, and the second transistor is connected to a second initialization voltage line.

### BRIEF DESCRIPTION OF THE DRAWINGS

FIG. 1 is a block diagram illustrating a display device in accordance with an embodiment of the present disclosure.

FIG. 2 is a circuit diagram illustrating first, second and third pixels shown in FIG. 1.

FIG. 3 is a circuit diagram illustrating a switching circuit in accordance with an embodiment of the present disclosure.

FIG. 4 is a block diagram illustrating an embodiment of an initialization voltage generator and a pixel unit, which are shown in FIG. 1.

FIG. 5 is a block diagram illustrating an embodiment of the initialization voltage generator and the pixel unit, which are shown in FIG. 1.

### DETAILED DESCRIPTION OF THE EMBODIMENTS

Example embodiments of the present disclosure will now be described more fully hereinafter with reference to the accompanying drawings; however, the present disclosure may be embodied in different forms and should not be construed as limited to the embodiments set forth herein.

In the drawings, dimensions may be exaggerated for clarity of illustration. It will be understood that when an element is referred to as being “between” two elements, it can be the only element between the two elements, or one or more intervening elements may also be present. Like reference numerals may refer to like elements throughout.

In addition, terms including “unit,” “module,” and the like, which are used herein, refer to units which perform at least one function or operation, and the unit, the module, and the like may be implemented as hardware, software, or a combination of hardware and software.

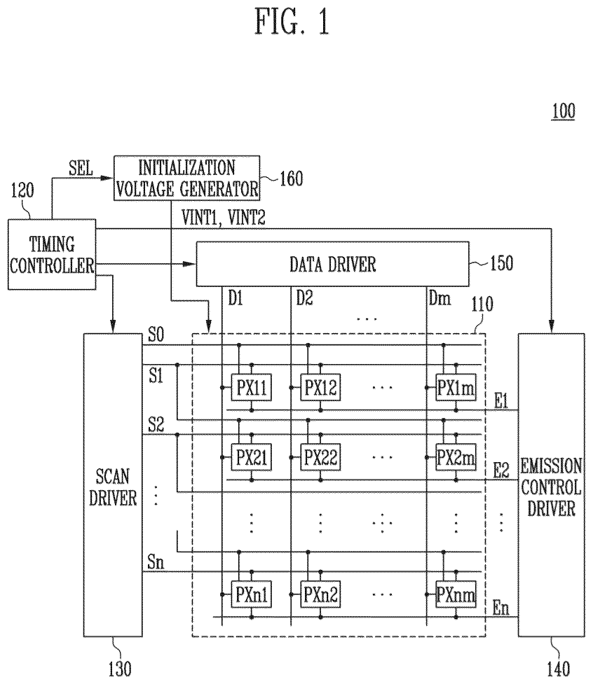

FIG. 1 is a block diagram illustrating a display device in accordance with an embodiment of the present disclosure.

Referring to FIG. 1, a display device 100 in accordance with an embodiment of the present disclosure may include a pixel unit 110, a timing controller 120, a scan driver 130, an emission control driver 140, a data driver 150, and an initialization voltage generator 160.

The pixel unit 110 may include a plurality of pixels PX11, PX12, . . . , PX1m, PX21, PX22, . . . , PXn1, PXn2, . . . , and PXnm. Each of the pixels PX11, PX12, . . . , PX1m, PX21, PX22, . . . , PXn1, PXn2, . . . , and PXnm may be connected to a corresponding data line and a corresponding scan line, and receive a data voltage input corresponding to a scan signal. Each of the pixels PX11, PX12, . . . , PX1m, PX21, PX22, . . . , PXn1, PXn2, . . . , and PXnm may enable an organic light emitting diode to emit light, corresponding to the input data voltage, and accordingly, the pixel unit 110 may display an image screen.

The timing controller 120 may receive control signals and image signals, which are supplied from a processor, and supply control signals and image signals to the scan driver 130, the emission control driver 140, the data driver 150, and the initialization voltage generator 160.

The scan driver 130 may receive a control signal from the timing controller 120. In response to the control signal from the timing controller 120, the scan driver 130 may generate a scan signal to be supplied to a plurality of scan lines S0, S1, S2, . . . , Sn. In accordance with an embodiment, the scan driver 130 may sequentially supply the scan signal through the plurality of scan lines S0, S1, S2, . . . , and Sn. For example, the control signal may include a gate start pulse (GSP) and a plurality of gate clock signals. In this case, the scan driver 130 may be configured with a plurality of shift registers to generate the scan signal in a manner that sequentially transfers the GSP to a next stage circuit under the control of a clock signal.

The emission control driver 140 may supply an emission control signal for determining emission periods of the plurality of pixels PX11, PX12, . . . , PX1m, PX21, PX22, . . . , PXn1, PXn2, . . . , and PXnm through emission control lines E1, E2, . . . , and En. For example, each pixel of the plurality of pixels PX11, PX12, . . . , PX1m, PX21, PX22, . . . , PXn1, PXn2, . . . , and PXnm may include an emission control transistor, and light emission of each pixel of the plurality of pixels PX11, PX12, . . . , PX1m, PX21, PX22, . . . , PXn1, PXn2, . . . , and PXnm may be controlled by determining whether a current is to flow through the organic light emitting diode on the basis of whether the emission control transistor is on or off. In accordance with an embodiment, the emission control driver 140 may be configured in a sequential emission type which enables pixel rows to sequentially emit light. In accordance with another embodiment, the emission control driver 140 may be configured in a simultaneous emission type which enables all the pixel rows to simultaneously emit light.

The data driver 150 may receive a control signal and an image signal from the timing controller 120. In response to the control signal and the image signal from the timing controller 120, the data driver 150 may generate a data voltage to be supplied to a plurality of data lines D1, D2, . . . , and Dm. The data voltage generated in units of pixel rows may be simultaneously applied to the plurality of data lines D1, D2, . . . , and Dm according to an output control signal included in the control signal received from the timing controller 120.

The initialization voltage generator 160 may apply a first initialization voltage VINT1 and a second initialization voltage VINT2 to the pixel unit 110. The first initialization voltage VINT1 and the second initialization voltage VINT2 may be supplied to an anode of the organic light emitting diode included in each pixel of the plurality of pixels PX11, PX12, . . . , PX1m, PX21, PX22, . . . . PXn1, PXn2, . . . , and PXnm to initialize a quantity of charges accumulated in the organic light emitting diode

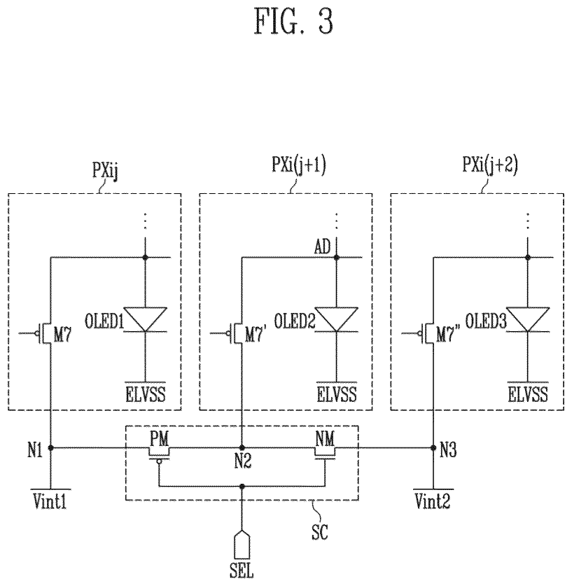

In an embodiment, the initialization voltage generator 160 may apply one of the first initialization signal VINT1 and the second initialization VINT2 to each pixel of the pixel unit 110, based on a select signal SEL. The timing controller 120 may output the select signal SEL to the initialization voltage generator 160. This will be described in more detail with reference to FIG. 3.

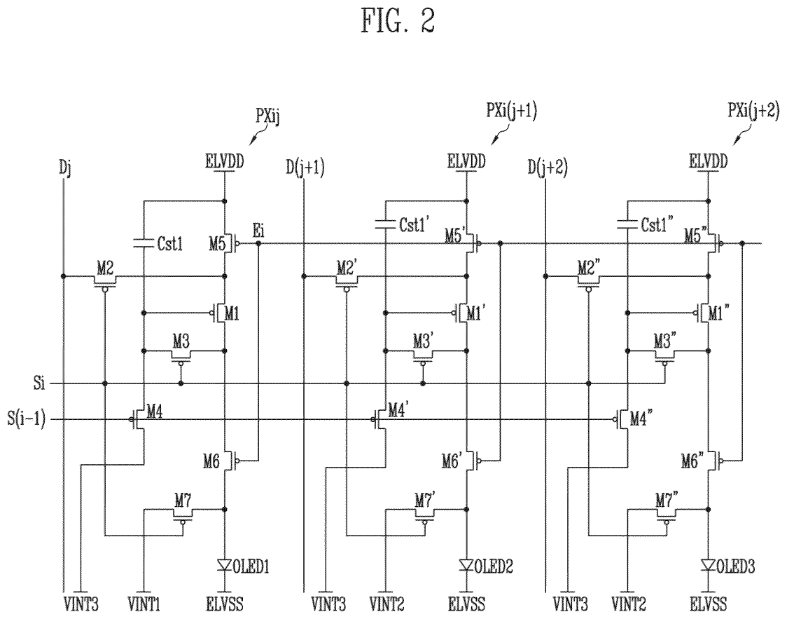

FIG. 2 is a circuit diagram illustrating first to third pixels shown in FIG. 1.

Referring to FIG. 2, a first pixel PXij, a second pixel PXi(j+1), and a third pixel PXi(j+2) are illustrated. The first pixel PXij may include a plurality of transistors M1, M2, M3, M4, M5, M6, and M7 and a first organic light emitting diode OLED1.

Hereinafter, a circuit configured with a P-type transistor will be described as an example. However, those skilled in the art may design a circuit configured with an N-type transistor by changing the polarity of a voltage applied to a gate terminal thereof. Similarly, those skilled in the art may design a circuit configured with a combination of P-type and N-type transistors.

The P-type transistor is commonly referred to as a transistor where the amount of current flowing through it increases when the voltage difference between a gate terminal and a source terminal increases in a negative direction. The N-type transistor is referred to as a transistor where the amount of current flowing through it increases when the voltage difference a gate terminal and a source terminal increases in a positive direction. The transistor may be configured in various forms such as a thin film transistor (TFT), a field effect transistor (FET), and a bipolar junction transistor (BJT).

A first electrode of a transistor M1 may be connected to a second electrode of a transistor M5, a second electrode of the transistor M1 may be connected to a first electrode of a transistor M6, and a gate electrode of the first transistor M1 may be connected to a second electrode of a storage capacitor Cst1. The transistor M1 may be referred to as a first driving transistor. The transistor M1 determines an amount of driving current flowing between a second power voltage ELVDD and the first power voltage ELVSS according to a potential difference between the gate electrode and a source electrode thereof.

A first electrode of a transistor M2 may be connected to a data line Dj, a second electrode of the transistor M2 may be connected to the first electrode of the transistor M1, and a gate electrode of the transistor M2 may be connected to a scan line Si of a current stage. The transistor M2 may be referred to as a first scan transistor. When a scan signal having a turn-on level is applied to the scan line Si of the current stage, the transistor M2 allows a data voltage of the data line Dj to be applied to the first pixel PXij.

A first electrode of a transistor M3 may be connected to the second electrode of the first electrode M1, a second electrode of the transistor M3 may be connected to the gate electrode of the first transistor M1, and a gate electrode of the transistor M3 may be connected to the scan line Si of the current stage. When the scan signal having the turn-on level is applied to the scan line Si of the current stage, the transistor M3 may allow the transistor M1 to be diode-connected.

A first electrode of a transistor M4 may be connected to the gate electrode of the transistor M1, a second electrode of the transistor M4 may be connected to a third initialization voltage VINT3, and a gate electrode of the transistor M4 may be connected to a scan line S(i−1) of a previous stage. The third initialization voltage VINT3 may be supplied to a driving transistor (e.g., the transistor M1) included in a pixel, to initialize a quantity of charges accumulated in a gate terminal of the driving transistor. In this embodiment, a value of the third initialization voltage VINT3 is not separately defined, but may be a fixed value. In addition, the initialization voltage generator 160 may generate the third initialization voltage VINT3.

In another embodiment, the gate electrode of the transistor M4 may be connected to another scan line. When the scan signal having the turn-on level is applied to the scan line S(i−1) of the previous stage, the transistor M4 allows a quantity of charges accumulated in the gate electrode of the transistor M1 to be initialized by supplying the third initialization voltage VINT3 to the gate electrode of the transistor M1.

A first electrode of the transistor M5 may be connected to the second power voltage ELVDD, the second electrode of the transistor M5 may be connected to the first electrode of the transistor M1, and a gate electrode of the transistor M5 may be connected to an emission control line Ei. The first electrode of the transistor M6 may be connected to the second electrode of the transistor M1, a second electrode of the transistor M6 may be connected to an anode of the first organic light emitting diode OLED1, and a gate electrode of the transistor M6 may be connected to the emission control line Ei. The transistors M5 and M6 may be referred to as emission control transistors. When an emission control signal having the turn-on level is applied to the emission control line Ei, the transistors M5 and M6 allow the first organic light emitting diode OLED1 to emit light by forming a driving current path between the second power voltage ELVDD and the first power voltage ELVSS.

A first electrode of a transistor M7 may be connected to the anode electrode of the first organic light emitting diode OLED1, a second electrode of the transistor M7 may be connected to a first initialization voltage VINT1, and a gate electrode of the transistor M7 may be connected to the scan line Si of the current stage. In another embodiment, the gate electrode of the transistor M7 may be connected to another scan line. When the scan signal having the turn-on level is applied to the scan line Si of the current stage, the transistor M7 allows a quantity of charges accumulated in the first organic light emitting diode OLED1 to be initialized by supplying the first initialization voltage VINT1 to the anode of the first organic light emitting diode OLED1.

The anode of the first organic light emitting diode OLED1 may be connected to the second electrode of the transistor M6, and a cathode of the first organic light emitting diode OLED1 may be connected to the first power voltage ELVSS.

The second pixel PXi(j+1) may include a plurality of transistors M1′, M2′, M3′, M4′, M5′, M6′, and M7′, a storage capacitor Cst1′ and a second organic light emitting diode OLED2.

Overlapping descriptions of components of the second pixel PXi(j+1), which corresponding to the components of the first pixel PXij, will be omitted.

The second pixel PXi(j+1) is different from the first pixel PXij, in that a data line D(j+1) is connected to a first electrode of a transistor M2′, and a second initialization voltage VINT2 is applied to a second electrode of a transistor M7′.

The third pixel PXi(j+2) may include a plurality of transistors M1″, M2″, M3″, M4″, M5″, M6″, and M7″, a storage capacitor Cst1″ and a third organic light emitting diode OLED3.

Overlapping descriptions of components of the third pixel PXi(j+2), which corresponding to the components of the first pixel PXij, will be omitted.

The third pixel PXi(j+2) is different from the first pixel PXij, in that a first electrode of a transistor M2″ is connected to a data line D(j+2), and the second initialization voltage VINT2 is applied to a second electrode of a transistor M7″.

In some embodiments, the first organic light emitting diode OLED1 may be a red organic light emitting diode. The second organic light emitting diode OLED2 may be a green organic light emitting diode. The third organic light emitting diode OLED3 may be a blue organic light emitting diode. In other words, the first pixel PXij may be a red pixel, the second pixel PXi(j+1) may be a green pixel, and the third pixel PXi(j+2) may be a blue pixel.

However, the embodiment of the present disclosure is not limited thereto. For example, the first organic light emitting diode OLED1 may be the blue organic light emitting diode. The third organic light emitting diode OLED3 may be the red organic light emitting diode.

Since the first to third organic light emitting diodes OLED1 to OLED3 emit lights of different colors, an initialization voltage required by each colored organic light emitting diode may vary.

For example, the first organic light emitting diode OLED1, which is the red organic light emitting diode, may require an initialization voltage lower than an initialization voltage of the third organic light emitting diode OLED3, which is the blue organic light emitting diode.

To set an initialization voltage that is optimized for each colored organic light emitting diode, the first initialization voltage VINT1 may be applied to the first organic light emitting diode OLED1, and the second initialization voltage VINT2 may be applied to the third organic light emitting diode OLED3.

However, in the case of the second organic light emitting diode OLED2 shown in FIG. 2, the second initialization voltage VINT2 equal to the initialization voltage applied to the third organic light emitting diode OLED3 may be applied to the second organic light emitting diode OLED2, regardless of the initialization voltage optimized that is optimized for the second organic light emitting diode OLED2. Accordingly, there may be a need for a method to set the initialization voltage optimized for the second organic light emitting diode OLED2 without increasing the number of power voltages.

FIG. 3 is a circuit diagram illustrating a switching circuit in accordance with an embodiment of the present disclosure.

Referring to FIG. 3, a first pixel PXij, a second pixel PXi(j+1), a third pixel PXi(j+2), and a switching circuit SC are illustrated. Hereinafter, the first pixel PXij, the second pixel PXi(j+1), and the third pixel PXi(j+2) may be described similarly to the first pixel PXij, the second pixel PXi(j+1), and the third pixel PXi(j+2), which are shown in FIG. 2, and overlapping descriptions will be simplified or omitted.

The switching circuit SC may supply one of the first initialization voltage VINT1 and the second initialization voltage VINT2 to an anode AD of a second organic light emitting diode OLED2, based on a select signal SEL. In other words, one of the first initialization voltage VINT1 and the second initialization voltage VINT2 may be provided to the anode AD of the second organic light emitting diode OLED2 in response to the select signal SEL input to the switching circuit SC.

The switching circuit SC may include a first transistor PM and a second transistor NM. The first transistor PM may be connected between a first node N1 and a second node N2, and operate based on the select signal SEL. For example, the select signal SEL may be provided to the gate of the first transistor PM. The first node NI may be a node at which a transistor M7 of the first pixel PXij is supplied with the first initialization voltage VINT1. The second node N2 may be a node at which a transistor M7′ of the second pixel PXi(j+1) is supplied with the first initialization voltage VINT1 or the second initialization voltage VINT2.

The second transistor NM may be connected between the second node N2 and a third node N3, and operate based on the select signal SEL. For example, the select signal SEL may be provided to the gate of the second transistor NM. The third node N3 may be a node at which a transistor M7″ of the third pixel PXi(j+2) is supplied with the second initialization voltage VINT2.

In other words, when the select signal SEL having a turn-on level of the first transistor PM is applied to the switching circuit SC, the switching circuit SC may supply the first initialization voltage VINT1 to the anode AD of the second organic light emitting diode OLED2 through the transistor M7′. When the select signal SEL having a turn-on level of the second transistor NM is applied to the switching circuit SC, the switching circuit SC may supply the second initialization voltage VINT2 to the anode AD of the second organic light emitting diode OLED2 through the transistor M7′.

The switching circuit SC may receive the select signal SEL from the timing controller 120 shown in FIG. 1. In an embodiment, the timing controller 120 may change a voltage level of the select signal SEL. For example, the timing controller 120 may output the select signal SEL having the turn-on level of the first transistor PM during a first period, and output the select signal SEL having the turn-on level of the second transistor NM during a second period after the first period. A length of the first period and a length of the second period may be freely set. For example, the length of the first period and the length of the second period can be set independently of each other.

In an embodiment, the first transistor PM may be a P-type transistor, and the second transistor NM may be an N-type transistor. However, the present disclosure is not limited thereto. The first transistor PM may be the N-type transistor, and the second transistor NM may be the P-type transistor.

Based on the select signal SEL, one of the first initialization voltage VINT1 and the second initialization voltage VINT2 may be supplied to the anode AD of the second organic light emitting diode OLED2. In other words, unlike that shown in FIG. 2 in which only the second initialization voltage VINT2 is supplied to the anode AD of the second organic light emitting diode OLED2, a voltage appropriate for use as an initialization voltage may be selected from the first initialization voltage VINT1 and the second initialization voltage VINT2. The selected initialization voltage may then be supplied to the anode AD of the second organic light emitting diode OLED2.

Since an optimized initialization voltage is supplied to each of first to third organic light emitting diodes OLED1 to OLED3, the image quality of the display device 100 can be enhanced, degradation of the pixels of the pixel unit 110 can be prevented, and the reliability of the display device 100 can be improved.

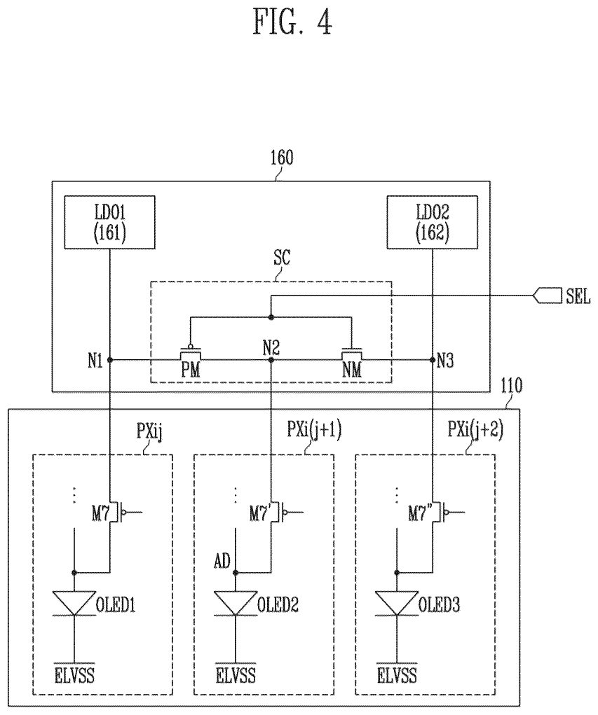

FIG. 4 is a block diagram illustrating an embodiment of the initialization voltage generator and the pixel unit, which are shown in FIG. 1.

Referring to FIG. 4, the initialization voltage generator 160 may include a switching circuit SC. The switching circuit SC may be described similarly to the switching circuit SC shown in FIG. 3, and first to third pixels PXij, PXi(j+1), and PXi(j+2) may be described similarly to the first to third pixels PXij, PXi(j+1), and PXi(j+2) shown in FIG. 3. Therefore, overlapping descriptions will be simplified or omitted.

The initialization voltage generator 160 may supply one of the first initialization voltage VINT1 and the second initialization voltage VINT2 to an anode AD of a second organic light emitting diode OLED2, based on a select signal SEL. The initialization voltage generator 160 may supply the first initialization voltage VINT1 to an anode of a first organic light emitting diode OLED1, and supply the second initialization voltage VINT2 to an anode of a third organic light emitting diode OLED3.

The initialization voltage generator 160 may include a first Low-Dropout regulator (LDO) 161, a second LDO 162, and the switching circuit SC. The first LDO 161 may generate the first initialization voltage VINT1. The second LDO 162 may generate the second initialization voltage VINT2.

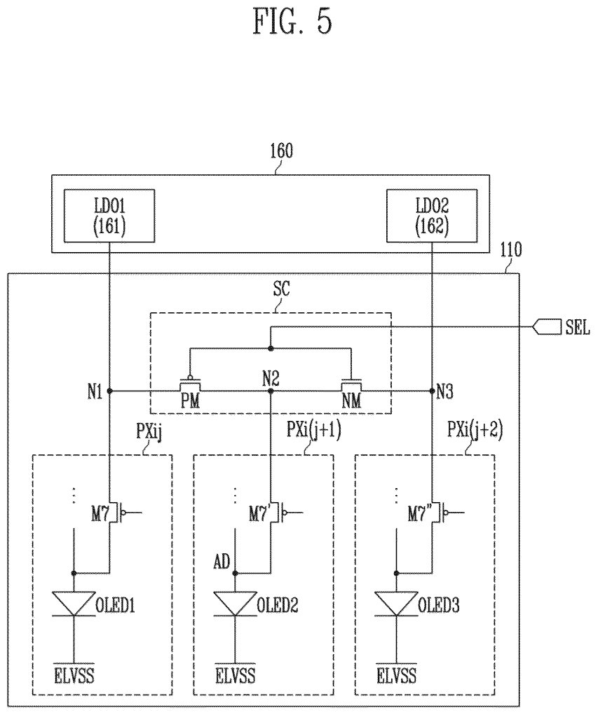

FIG. 5 is a block diagram illustrating an embodiment of the initialization voltage generator and the pixel unit, which are shown in FIG. 1.

Referring to FIG. 5, the pixel unit 110 may include a switching circuit SC. The switching circuit SC may be described similarly to the switching circuit SC shown in FIG. 3, and first to third pixels PXij, PXi(j+1), and PXi(j+2) may be described similarly to the first to third pixels PXij, PXi(j+1), and PXi(j+2) shown in FIG. 3. Therefore, overlapping descriptions will be simplified or omitted.

The switching circuit SC may supply one of the first initialization voltage VINT1 and the second initialization voltage VINT2 to an anode AD of a second organic light emitting diode OLED2, based on a select signal SEL.

The initialization voltage generator 160 may include a first LDO 161 and a second LDO 162. The first LDO 161 may generate the first initialization voltage VINT1. The second LDO 162 may generate the second initialization voltage VINT2. The first LDO 161 may supply the first initialization voltage VINT1 to an anode of a first organic light emitting diode OLED1. The second LDO 162 may supply the second initialization voltage VINT2 to an anode of a third organic light emitting diode OLED3.

In the display device in accordance with the present disclosure, an optimized driving voltage can be supplied to an organic light emitting diode of each color through a switching circuit.

Example embodiments of the present disclosure have been disclosed herein, and although specific terms are employed, they are used and are to be interpreted in a generic and descriptive sense and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and detail may be made without departing from the spirit and scope of the present disclosure as set forth in the following claims.

What is claimed is:

1. A display device comprising:
a first pixel including a first organic light emitting diode; and
an initialization voltage generator configured to generate a first initialization voltage and a second initialization voltage, and supply one of the first initialization voltage and the second initialization voltage to a first anode of the first organic light emitting diode, in response to a select signal.

2. The display device of claim 1, further comprising:
a second pixel including a second organic light emitting diode; and
a third pixel including a third organic light emitting diode,
wherein the initialization voltage generator:
supplies the first initialization voltage to a second anode of the second organic light emitting diode; and
supplies the second initialization voltage to a third anode of the third organic light emitting diode.

3. The display device of claim 2, wherein the initialization voltage generator includes:
a first Low-Dropout regulator (LDO) configured to generate the first initialization voltage;
a second LDO configured to generate the second initialization voltage; and
a switching circuit configured to supply one of the first initialization voltage and the second initialization voltage to the first anode of the first organic light emitting diode, in response to the select signal.

4. The display device of claim 3, wherein the switching circuit includes:
a first transistor connected between the first anode of the first organic light emitting diode and the second anode of the second organic light emitting diode, the first transistor operating in response to the select signal; and
a second transistor connected between the first anode and the third anode of the third organic light emitting diode, the second transistor operating in response to the select signal.

5. The display device of claim 4, wherein the first transistor is a P-type transistor, and the second transistor is an N-type transistor.

6. The display device of claim 4, wherein, when the select signal turns on the first transistor, the first initialization voltage is supplied to the first anode of the first organic light emitting diode, and
wherein, when the select signal turns on the second transistor, the second initialization voltage is supplied to the first anode of the first organic light emitting diode.

7. The display device of claim 2, wherein the first pixel is a green pixel, the second pixel is a red pixel, and the third pixel is a blue pixel.

8. A display device comprising:
a display unit including a first pixel including a first organic light emitting diode and a switching circuit configured to supply one of a first initialization voltage and a second initialization voltage to a first anode of the first organic light emitting diode, in response to a select signal; and
an initialization voltage generator configured to generate the first initialization voltage and the second initialization voltage.

9. The display device of claim 8, further comprising:
a second pixel including a second organic light emitting diode; and
a third pixel including a third organic light emitting diode,
wherein the initialization voltage generator:
supplies the first initialization voltage to a second anode of the second organic light emitting diode; and
supplies the second initialization voltage to a third anode of the third organic light emitting diode.

10. The display device of claim 9, wherein the initialization voltage generator includes:
a first Low-Dropout regulator (LDO) configured to generate the first initialization voltage; and
a second LDO configured to generate the second initialization voltage.

11. The display device of claim 9, wherein the switching circuit includes:
a first transistor connected between the first anode and the second anode, the first transistor operating in response to the select signal; and
a second transistor connected between the first anode and the third anode, the second transistor operating in response to the select signal.

12. The display device of claim 11, wherein the first transistor is a P-type transistor, and the second transistor is an N-type transistor.

13. The display device of claim 11, wherein, when the select signal turns on the first transistor, the first initialization voltage is supplied to the first anode, and
wherein, when the select signal turns on the second transistor, the second initialization voltage is supplied to the first anode.

14. The display device of claim 9, wherein the first pixel is a green pixel, the second pixel is a red pixel, and the third pixel is a blue pixel.

15. A display device comprising:
a first pixel including a first organic light emitting diode; and
a switching circuit configured to apply one of a first initialization voltage and a second initialization voltage to a first anode of the first organic light emitting diode, in response to the select signal.

16. The display device of claim 15, wherein the switching circuit includes a first transistor that is activated in response to a first level of the select signal and a second transistor that is activated in response to a second level of the select signal.

17. The display device of claim 16, wherein the first transistor is connected to a first initialization voltage line, and the second transistor is connected to a second initialization voltage line.
